(19) United States
(12) Patent Application Publication
(10) Pub. No.: US 2003/0072999 A1
(43) Pub. Date: Apr. 17, 2003

(54) Method for manufacturing an electrode-separator assembly for galvanic elements

(75) Inventors: Peter Birke, Ellwangen (DE); Fatima Birke-Salam, Ellwangen (DE); Konrad Holl, Aalen-Dewangen (DE); Peter Haug, Ellwangen (DE); Heinrich Stelzig, Rosenberg (DE); Dejan Ilic, Ellwangen (DE)

Correspondence Address: SCHNADER HARRISON SEGAL & LEWIS, LLP, 1600 MARKET STREET, SUITE 3600, PHILADELPHIA, PA, 19103

(73) Assignee: Varta Microbattery GmbH

(21) Appl. No.: 10/268,454

(22) Filed: Oct. 10, 2002

(30) Foreign Application Priority Data
Oct. 11, 2001 (DE) DE 101 50 227.3

(51) Int. Cl. H01M 4/62; H01M 2/16; H01M 10/04

(52) U.S. Cl. 429/217; 429/254; 29/623.3

(57) ABSTRACT

A method for manufacturing electrode-separator assemblies for galvanic elements includes hot-lamination at temperatures close to the melting point or softening point of at least a portion of the surface of an electrode or separator to a separator or electrode, respectively.

### RELATED APPLICATION

This patent application claims priority of German Patent Application No. 101 502 27.3, filed Oct. 11, 2001.

### FIELD OF THE INVENTION

This invention relates to a method for manufacturing an electrode-separator assembly for galvanic elements that contain at least one lithium intercalating electrode in whose polymer matrix insoluble, electrochemically active materials are finely distributed in the polymer. The invention also relates to a galvanic element having an electrode-separator assembly manufactured according to the invention.

### BACKGROUND

Widely varying methods for manufacturing galvanic elements having foil electrodes that employ lithium intercalating materials as their active compounds are known:

European Patent Application No. 954,042 A1 discloses a lithium-ion storage battery whose positive and negative foil electrodes are bonded to a separator by a layer of adhesive resin. In particular, these adhesive layers may have an undesirable insulating effect between electrodes and separators; namely, they may inhibit electron diffusion and thereby increase cell internal resistance. They may also introduce undesirable materials into the cells.

European Patent Application No. 1,056,142 A1 discloses a lithium-ion cell having a gel electrolyte arranged between its positive and negative foil electrodes. In particular, this gel consists of polyvinylidene fluoride or copolymers of polyvinylidene fluoride, such as hexafluoropropylene. The manufacture of such cells is time-consuming, since their electrodes and gel electrolytes must be processed in a dry environment. Furthermore, such electrolytes frequently fail to yield sufficiently high electrical conductivities.

A method for applying a paste mixture containing graphite to a mechanically stable carrier foil, for example, a copper foil, followed by a separator strip consisting of a polymer mixture and SiO₂ in paste form, and processing the resultant assembly to yield a foil is known from German Patent Application No. 19916 041 A1. Methods of this type necessitate employing relatively thick separator layers that increase cell internal resistance and reduce cell energy densities to prevent adjacent layers of the active medium from contacting one another through the gel-like separator strips.

The electrodes employed on such galvanic elements are usually based on foils manufactured by wet-chemical methods, wherein large quantities of active material, usually more than 70% by weight, are suspended in a dissolved binder polymer and drawn into a foil by spreaders. That suspension also contains plasticizers and electrical-conductivity enhancers, whenever necessary. Cell assemblies are manufactured by laminating these electrode foils onto foil drain electrodes and then laminating the resultant assemblies onto the separators in a subsequent lamination stage. Lamination usually takes place in a strip-laminator operated at a defined pressure and laminating temperatures ranging from 110° C. to 140° C.

U.S. Pat. No. 5,460,904 discloses an example of such a method. Lithium intercalated electrodes wherein their active medium is distributed in a polyvinylidene-fluoride-hexafluoropropylene-copolymer matrix are disclosed therein. A gel separator fabricated from that same material, with SiO₂ employed as a filler, is arranged between these electrodes. The electrodes and separators are then laminated to form cell assemblies.

Filler separators having a polymer as a binder and a binary oxygen compound such as Al₂0₃ or, in particular, baked SiO₂, as a filler having a very large effective surface area cause several inherent problems. Since exclusively conducting salts, such as LiPF₆, LiBF₄ and the like, may be employed in 4-volt systems on stability grounds even though they readily hydrolyze and, due to the time and expense restrictions imposed by mass-production operations, invariably have residual water contents ranging from several tens of ppm to several hundred ppm, fillers containing oxygen may trigger a cycle that may be described as follows, where the conducting salt initially decomposes by means of the following reaction:

LiPF₆→PF₅↑+LiF↓.

This decomposition occurs at a rate that decreases slightly as time passes, but will be accelerated by influences, such as light or higher temperatures. PF₅ is the initial decomposition product that readily hydrolyzes and reacts with traces of water, liberating HF in the process, according to the reaction:

PF₅+H₂O→POF₃+2 HF.

HF usually reacts with compounds containing oxygen, liberating water in the process. As an example thereof, there is the reaction with SiO₂:

SiO₂+4 HF→SiF₄+2 H₂O.

Although this reaction process at a very slow rate at room temperature, it is invariably maintained by the resultant resupply of H₂O.

Over extended periods, excessively high HF-concentrations necessarily cause adverse effects due to corrosion, passivation of the drain electrodes, and destruction and dissolution of the so-called “solid-electrolyte interfaces” (SEI's), ionically conductive layers of slid electrolyte that form an, at least, kinetically stable reaction product of the initial decomposition of the liquid organic electrolytes during charging of the cells, and thus prevent further decomposition of the liquid organo-lithium electrolytes. This dissolution process may, in particular, be highly accelerated by higher temperatures (60° C.-80° C.) and cause cell gassing. Slow growth of SEI's at room temperature due to their flaking off and reforming increases cell resistance, which is reflected in a decrease in cell capacity for a given discharge current over the total number of charging/discharging cycles involved.

A second major weakness of these filler separators is their low pliability, which makes them difficult to laminate, particularly if large quantities of plasticizers have to be incorporated into them, and means that short-circuiting hazards will have to be counteracted by increasing their thickness which, in turn, increases cell resistance, thereby reducing cell energy densities, and introduces more filler material that generates fluctuating and steadily rising concentrations of water and liquid acids in accordance with the reaction paths described above. Moreover, the plasticizer may have to be extracted by employing a time-consuming, expensive process, since it will usually be electrochemically incompatible with the other materials involved.

Separator materials that are chemically inert and, although they are in the form of very thin foils are, nevertheless, still stable and may be readily processed on mass-production scales, are thus of great interest. Polyolefins, such as polypropylene (PP), polyethylene (PE), or laminates consisting of alternating (PE-PP-PE) layers of these materials, closely comply with these requirements and have thus been employed in wound lithium cells for quite a while. Polyolefin separators also possess an inherent safety mechanism, their so-called “shutdown”: in the case of a critical cell situation, such as short-circuiting or a mechanical penetration from outside, combined with a rapid rise in temperature, their pores, which are filled with liquid electrolyte, seal themselves, interrupting the internal, ionic flow of current within the cell, which causes the cell resistance to rapidly rise, and the cell will then no longer be able to rapidly heat up. Polyolefin separators are also less expensive and more environmentally friendly, where the aforementioned systems are, however, invariably reliant upon an external pressure that will have to be exerted either by elaborate spring mechanisms, special self-tensioning winding technologies employed in manufacturing the dry cells, or specially shaped housings equipped with pretensioners and comparable devices. However, it would be desirable to have a cell that would have a physical integrity before it is installed in a housing, which would allow for new types of extremely thin or flat designs and would, in general, be of advantage in that it would provide better electrode-separator contact.

Employment of PP-PE-separators or laminar composites consisting of stacked PP-PE-duolayers coated with the electrode binder employed is also known. For example, WO/00690 10 discloses a lithium-ion cell that employs a polyolefin separator that is coated with the same binder polymer as its electrodes between its positive and negative electrodes. However, this approach is time-consuming and expensive, since the separator must first be wet-chemically coated and then laminated as well, which imposes severe restrictions on the cell assembly's manufacturing parameters.

It would, therefore, be advantageous to provide a method for manufacturing an electrode-separator assembly of the type mentioned at the outset hereof, wherein, in particular, the processing involved may be performed in an ambient environment and employ a wide variety of polyolefin-based separators and electrode materials.

### SUMMARY OF THE INVENTION

This invention relates to a method for manufacturing an electrode-separator assembly for a galvanic element containing at least one lithium intercalating electrode, the electrode having 1) a polymer matrix with a polymer and 2) insoluble, electrochemically active materials finely distributed in the polymer of the polymer matrix, and a polyolefin separator, including hot-laminating, at a temperature close to a melting point or softening point of at least a portion of a surface portion of the electrode or the separator with the separator or the electrode, respectively.

### BRIEF DESCRIPTION OF THE DRAWING

FIG. 1 is a graph plotting the capacities, C, of two cells manufactured employing the method of the Example as a function of the number of charging/discharging cycles, n.

### DETAILED DESCRIPTION

Employing the method according to the invention solves the problem of employing uncoated separators by proceeding as follows: choosing a temperature close to the melting point or softening point of a polymer material employed for manufacturing the electrodes as the laminating temperature and employing a separator material whose melting point exceeds that of the electrode material to prevent shorting of the electrodes due to their physically contacting one another through the separator material. An example of such an arrangement involves employing polyvinylidene-fluoride-hexafluoropropylene (PVDF-HFP) whose PVDF/HFP ratio has been chosen such that its melting point or softening point falls within the range of about 140° -about 150° C. as the electrode polymer. An example is ElfAtofina “Powerflex”. The separator employed is most preferably a PP-monolayer separator having a melting point of about 160° C. The PVDF-HFP electrode binder employed somewhat penetrates into the pores of the PP-separator when it softens and, thus, bonds the electrode to the separator.

When hot-lamination, in particular, strip-lamination, is employed, it has, surprisingly, been found that cells having PP-PE-PP-based separators may be manufactured at laminating temperatures close to the latter's melting points or softening points, even though PE has a shutdown temperature of about 120° C. It is preferred that the lamination temperature be within about 30° C. of the melting points or softening points, most preferably within about 10 to about 20° C. While not being bound by any particular theory, it appears that the short dwell times at selected pressures in the laminators apparently reperforates the separator, or at least keeps its existing pores open, instead of sealing them, in spite of the high temperatures employed.

If the melting points or softening points of separators are additionally, or exclusively, utilized for creating electrode-separator bonds, there still remains the latent danger that those electrodes will be shorted through their separators. Employing multilayer laminates comprising layers of the type PE-PP-PE is thus advisable in such cases. PP, whose melting point of about 160° C. exceeds that of PE, preferably remains the core foil and prevents physical contacting of the electrodes, whereas PE might even remain sufficiently thermoplastically deformable at temperatures of about 120° C.-about 130° C., without any disadvantageous sealing of its pores occurring. An especially preferred embodiment involves additional use of outer PE-layers that have relatively large pores to provide for optimal penetration thereof by the materials of electrode foils.

In the case of another preferred embodiment of the method according to the invention, partially coated or spot-coated separators may be employed. Spot-coating with an adhesion-enhancing material replaces employment of a thermoplastic adhesive, and that portion of separators that are to be spot-coated, which is typically about 5%, is chosen to be small so that any lack of, or insufficient, electrolyte penetration into spot-coated areas and the side electrochemical reactions at separator-negative-electrode phase boundaries that are invariably confined to locations where coatings are present will remain within acceptable tolerances.

That additional coating may cover about 1%-about 60%, preferably about 5%-about 10%, of the separator's surface and may comprise, in particular, polyvinylidene fluoride or polyvinylidene fluoride and hexafluoropropylene.

The additional coating of part of separators, which provides for an adhesion of electrodes and separators, makes certain that these components adhere to one another sufficiently well, even prior to their hot-lamination.

It is also beneficial if the surfaces of separators are pretreated in a corona discharge, wherein their surfaces are cleansed, modified, and activated by an electron beam, which significantly improves their adhesive properties.

A slight, merely localized, or even total, lack of adhesion by separators may be beneficial to their being uniformly and rapidly penetrated by liquid organo-lithium electrolytes when activating cells, i.e., when impregnating separators with liquid organo-lithium electrolytes, which is also beneficial from a safety standpoint since, in the event that cells are unintentionally overcharged, gases liberated as a result of the decomposition of their liquid electrolytes causes brief interruptions of electrical contact, which interrupts the flow of current.

Those polymers suitable for employment on electrode-separator assemblies according to the invention are, for example, polyvinylidene fluoride and hexafluoropolypropylene or water-soluble binders, where, for example, n-methyl pyrrolidine-2-pyrrolidone, acetone, or water may be employed as solvents. The porous separator material may consist of polypropylene, polyethylene, or multilayer laminates fabricated from various materials whose porosities may vary. The coatings on electrodes and/or separators may contain plasticizers.

The materials that may be employed for fabricating negative electrodes include, for example, metallic lithium, metals that may be alloyed with lithium, or modified forms of graphitized carbon, as well as intercalation compounds of mixed oxides, such as Li_{4/3}(Ti_{5/3})O₄, that have suitably located voltages. Positive electrodes may contain a lithium-cobalt-oxygen, lithium-nickel-oxygen, or lithium-manganese-oxygen compound that may also be stabilized by lithium, magnesium, aluminum, or fluorine as their intercalated lithium material.

The paste mixtures employed for fabricating negative-electrode foils contain about 55% to about 95%, preferably about 65% to about 85%, of the aforementioned classes of materials by weight. The paste mixtures employed for fabricating positive electrodes contain about 65% to about 98%, preferably about 65% to about 95%, of the positive-electrode material(s) by weight, referred to the dry weight of the paste involved in both cases. Wet paste mixtures according to the invention contain about 25% to about 50%, preferably about 35% to about 45%, of the dry-paste matter by weight. The rest is solvent, which is then added to bring the total weight up to 100%, referred to as total wet weight. The PVDF/HFP-ratios of positive-electrode foils range from a maximum of about 99.5 to a minimum of about 0.5, and preferably range from a maximum of about 80 to a minimum of about 20. The ratio of the molecular weight of PVDF to that of HFP ranges from about 3.2 to about 2.8, and preferably ranges from about 2.3 to about 2.5.

The PVDF/HFP-ratios of negative-electrode foils range from about 99.5 to about 0.5, and preferably range from about 85 to about 15. Their molecular-weight ratio ranges from about 3.2 to about 2.8, and preferably ranges from about 2.3 to about 2.5.

The pastes involved are manufactured such that the viscosities of the initial mixtures range from about 1 Pascal to about 10 Pascals, and preferably range from about 3 Pascals to about 6 Pascals.

Electrode pastes are initially spread either directly onto the surfaces of the conducting substrates or distributed over the surfaces of carrier foils at the intermediate spreading stage and then hot-laminated to manufacture galvanic elements. Cell assembly employs hot-lamination of the electrodes and separators, preferably involving a symmetrical arrangement of the type Electrode B-Separator-Electrode A-Separator-Electrode B, to prevent bending of the cell due to an asymmetric arrangement thereof.

### EXAMPLE

A paste to be employed for fabricating the negative electrode was manufactured by thoroughly mixing 4,812 g spherical graphite (“MCMB 25-28,” supplied by Osaka Gas), 138 g conductive carbon black (“Super P,” supplied by Erachem/Sedema), and 619 g “Powerflex” in 5 l acetone and then immediately spreading the resultant paste onto both sides of a copper foil. The surfaces of the copper foil were previously roughened by electrochemically extracting copper crystallites, and the resultant foil chromated. A paste to be employed for fabricating the positive electrode was manufactured by thoroughly mixing 2,973 g LiCoO₂, 206 g conductive carbon black (“Supper P,” supplied by Erachem/Sedema), and 310 g “Powerflex” in 5 l acetone and then immediately spreading the resultant paste onto both sides of a sheet of untreated, expanded aluminum (“Delker 2 Al 6-077 F”). This negative-electrode preform was cut into 6 cm×3 cm blanks having drain tabs on a punch press and then laminated onto a monolayer PP-separator (“Calgard 2500”) at 130° C. and a pressing pressure of 10 kg. Suitable punched cathode blanks, complete with drain tabs, were laminated onto both sides of the resultant bonded composite at 140° C. and a pressing pressure of 10 kg. The drain tabs on the negative ends of eight such bi-cells were ultrasonically welded to a solid-nickel (70 pm) conductor, the drain tabs on their positive ends were ultrasonically welded to an aluminum (70 pm) conductor, and the resultant stack was then packaged in deep-drawn aluminum foil that had been coated on both sides and activated employing 1 M LiPF₆ in a 7:3, by weight, mixture of diethyl carbonate and ethylene carbonate.

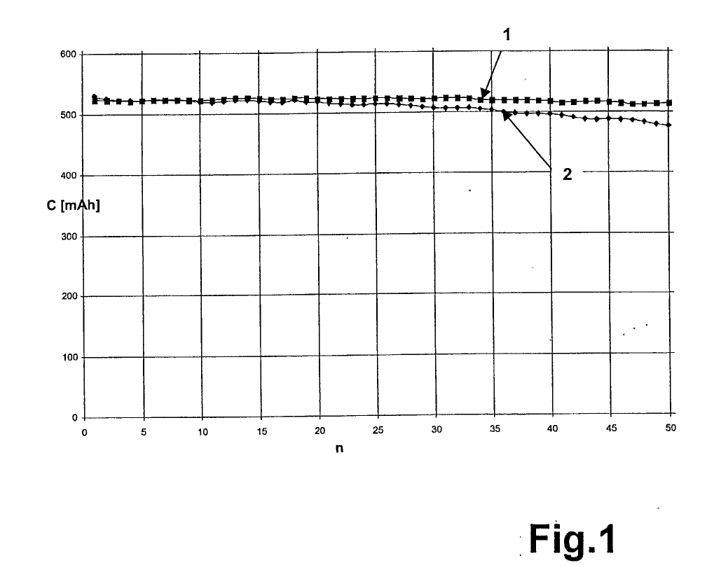

FIG. 1 is a graph plotting the capacities, C, of two cells manufactured employing the method of the above example as a function of the number of charging/discharging cycles, n. Both cells were charged to 4.2 Volts employing constant charging currents numerically equaling about 1.15 C and 1.4 C, which correspond to 600 mA (Curve 1) and 750 mA (Curve 2), held at that voltage for 3 h, and then discharged to 3.0 Volts employing discharging currents numerically equaling about 1.15 C and 1.4 C, which correspond to 600 mA (Curve 1) and 750 mA (Curve 2). The nearly flat resultant curves indicate that cells manufactured in this manner are highly reliable.

1. A method for manufacturing an electrode-separator assembly for a galvanic element containing at least one lithium intercalating electrode, said electrode having 1) a polymer matrix with a polymer and 2) insoluble, electrochemically active materials finely distributed in said polymer of said polymer matrix, and a polyolefin separator, comprising:
laminating, at a temperature close to a melting point or softening point of said electrode or said separator, at least a portion of a surface portion of said electrode or said separator with said separator or said electrode, respectively.

2. The method according to claim 1, further comprising coating a portion of said surface of said separator with an adhesion-enhancing coating.

3. The method according to claim 2, wherein said adhesion-enhancing coating covers about 1%-about 60% of said surface of said separator.

4. The method according to claim 1, wherein the electrode-separator assembly further comprises an electrode binder.

5. The method according to claim 4, wherein said electrode binder is polyvinylidene fluoride and additional portions of said separator surface are coated with an adhesion-enhancing coating.

6. The method according to claim 4, wherein said electrode binder is polyvinylidene fluoride and hexafluoropropylene and additional portions of said separator surface are coated with an adhesion-enhancing coating.

7. The method according to claim 4, further comprising a solvent in said electrode binder, wherein said solvent is selected from the group consisting of n-methyl pyrrolidine-2-pyrrolidone, acetone and water.

8. The method according to claim 1, wherein said electrode or said separator have a coating and said coating contains a plasticizer.

9. The method according to claim 1, wherein said separator comprises layers containing different polyolefins.

10. The method according to claim 9, wherein said polyolefins have different porosities.

11. The method according to claim 1, wherein said surface of said separator is pretreated in a corona discharge.

12. The method according to claim 1, wherein the temperature is within about 30° C. degrees of the melting point or softening point.

13. The method according to claim 1, wherein the temperature is within about 10-20° C. degrees of the melting point or softening point.

14. A galvanic element having at least one electrode-separator assembly manufactured according to the method of claim 1.

15. The galvanic element according to claim 14, wherein said electrode-separator assembly is laminated onto at least one drain electrode or electrode to form a stack, wherein said stack is impregnated with a liquid organic electrolyte.

16. A method for manufacturing an electrode-separator assembly comprising:
selecting at least one lithium intercalating electrode having 1) a polymer matrix with a polymer and 2) insoluble, electrochemically active materials finely distributed in said polymer of said polymer matrix;
selecting a polyolefin separator; and
laminating at least a portion of a surface of said electrode to at least a portion of a surface of said separator at a temperature approximately but less than the melting points or softening points of said electrode.

17. The method according to claim 16, wherein the temperature is within about 30° C. degrees of the melting point or softening point.

18. The method according to claim 16, wherein the temperature is within about 10-20° C. degrees of the melting point or softening point.

19. The method according to claim 16, wherein the polymer comprises polyvinylidine-fluoride-hexafluoropropylene.

20. The method according to claim 16, wherein the separator comprises polypropylene.

21. A galvanic element having at least one electrode-separator assembly manufactured according to the method of claim 16.

22. The galvanic element according to claim 21, wherein said electrode-separator assembly is laminated onto at least one drain electrode or electrode to form a stack, wherein said stack is impregnated with a liquid organic electrolyte.

23. A method for manufacturing an electrode-separator assembly comprising:
selecting at least one lithium intercalating electrode having 1) a polymer matrix with a polymer and 2) insoluble, electrochemically active materials finely distributed in said polymer of said polymer matrix;
selecting a polyolefin separator; and
laminating at least a portion of a surface of said separator to at least a portion of a surface of said electrode at a temperature approximately but less than the melting point or softening point of said separator.

24. The method according to claim 23, wherein the temperature is within about 30° C. degrees of the melting point or softening point.

25. The method according to claim 23, wherein the temperature is within about 10-20° C. degrees of the melting point or softening point.

26. The method according to claim 23, wherein the polymer comprises polyvinylidine-fluoride-hexafluoropropylene.

27. The method according to claim 23, wherein the separator comprises polypropylene.

28. A galvanic element having at least one electrode-separator assembly manufactured according to the method of claim 23.

29. The galvanic element according to claim 28, wherein said electrode-separator assembly is laminated onto at least one drain electrode or electrode to form a stack, wherein said stack is impregnated with a liquid organic electrolyte.
